(19) United States
(12) Patent Application Publication
(10) Pub. No.: US 2013/0194651 A1
(43) Pub. Date: Aug. 1, 2013

(54) Full Color Phase-Only Spatial Light Modulator for Holographic Video Display System

(71) Applicant: Light Field Corporation, Philadelphia, PA (US)

(72) Inventors: Arvind K. Srivastava, Des Plaines, IL (US); Fahri Yaras, Chelsea, MA (US)

(73) Assignee: Light Field Corporation, Philadelphia, PA (US)

(21) Appl. No.: 13/754,286

(22) Filed: Jan. 30, 2013

Related U.S. Application Data
(60) Provisional application No. 61/592,214, filed on Jan. 30, 2012.

(51) Int. Cl. G02F 1/01; G02B 26/00

(52) U.S. Cl. CPC G02F 1/01; G02B 26/00
USPC 359/279; 359/290; 29/825; 216/13

(57) ABSTRACT

Full-color phase-only spatial light modulators (SLM) are proposed for modulating phase of the light. Proposed SLMs are low-power electrically actuated surface micromachined MEMS device with high reflectivity, high switching speed, high diffraction efficiency, high fill-factor and low surface adhesion to the substrate.

### CROSS-REFERENCE TO RELATED APPLICATIONS

This application claims priority to the U.S. Provisional Patent Application entitled, “Full Color Phase-Only Spatial Light Modulator for Holographic Video Display Systems”, filed on Jan. 30, 2012, Ser. No 61/592,214, the contents of which are incorporated herein by reference.

### FIELD OF THE INVENTION

The present invention is in the technical field of optical modulators. More particularly, the present invention is in the technical field of spatial light modulators. More particularly, the present invention is in the technical field of phase-only spatial light modulators.

### BACKGROUND OF THE INVENTION

Today's 3D display systems produce a convincingly good 3D experience to one or more viewers with glasses (stereoscopic approach—e.g. active (alternate flame sequencing), passive (polarizing/color filters)) or without glasses (autostereoscopic approach—e.g. parallax barrier, lenticular arrays) by manipulating the light and tasking our brain to perceive sense of depth. Due to the underlying working mechanism of these technologies, prolonged viewing commonly leads to strain and discomfort.

None of these 3-D methods is holographic in nature. A true-holography, by contrast, creates “virtual” images that are really three-dimensional in space. Unlike stereoscopic techniques where separate light beams are steered to left and right eyes by some means, holography enables light field, which is generally the complex interference patterns generated by the product of a light source scattered off “objects”, to be recorded on some medium, called a “spatial light modulator” (SLM), such as a mask, film or LCD), and later reconstructed when placed in an original light source to produce the virtual image of the “objects” with full parallax.

SLM, as its name implies, modulates the illuminating light either by blocking the intensity of light (pure amplitude modulation) or retarding the light (pure phase modulation). For many purposes phase-SLM is preferred to amplitude-SLM, because the phase component of the complex field carries more information, and the efficiency (i.e. the fraction of the illuminated beam which is converted to the reconstructed object) is greater for phase than for amplitude-modulated holograms. There are various ways to modulate the phase of light, including by increasing the travel distance or thickness of the material by a fraction of the wavelength or by changing the retractive index so that the light travels more slowly.

Regardless of the approach used to modulate the phase, performance of existing solutions to 3D holography is limited due to size, lack of color and switching speed of spatial light modulators (SLMs). For high spatial resolution holography a large and dense array of small-size SLMs is required. The smaller the size of the SLMs, the higher the angular diffraction and wider the viewing zone of the resulting display. Current SLMs that are based on LCD and LCoS are already pushing the size limit and cannot be scaled down below 10 um. Apart from this their switching speed is typically on the order of 3 ms which is not enough for high speed color video display, see Refs. [1, 2].

Silicon based microfabrication and micromachining techniques offer novel solution to overcome these limitations. Breakthrough technical advances in the ability to fabricate and drive small pixel sizes are a productive area of innovation in this field for advancement of attaining realistic images. Novel methods are possible in MEMS optical components as demonstrated by the Sharp patent issued in 2011, see Ref. [3], which proposes a mechanism to produce analog color from a MEMS structure such as used in the Qualcomm Mirasol Display, see Ref. [4]. The Qualcomm's Mirasol Display is based on interferometric modulation (IMOD) approach but it is suitable for 2D display in portable devices. The Digital Mirror or Device (DMD) as developed by Texas Instruments, see Ref. [5], is another kind of very popular MEMS optical device for 2D projection applications. DMD modulates the light intensity by electrostatically deforming the mirror. Both the IMOD and DMD have been shown to outperform LCD and LCoS displays in terms of power consumption, color generation, contrast/reflectivity and switching speed but their applications have been limited only to 2D display and projections.

For generating a 3D virtual holographic image these MEMS structures must be modified to account for the relative phase shift between the neighboring pixels which is the basis for forming 3D holograms. One such architecture that fulfills this requirement is a moving piston type spatial light modulator developed by the group at Boston University (BU), see Ref. [6]. BU's SUM is a surface micromachined MEMS device that consists of a reflective metallic mirror supported by four flexures spanning out of the active area on top of the bottom metal electrode. These MEMS SLMs modulate the light in phase, but they are non-diffractive due to their fairly big size (100 um×100 um) and hence are not suitable for holographic display. Furthermore, structurally they have large dead-space on the wafer which negatively affects the fill-factor. Also, the flexures are exposed in the dead-space, and provide unwanted and uncontrolled light scattering. In order for these SLMs to be diffractive their size must be reduced. A simple calculation suggests that as the size of SUM is reduced from 100 um×100 um to 10 um×10 um, for example, fill-factor decreases by 32% (i.e. from 84% to 51%) and the drive voltage increases to an unacceptably large value if the flexure aspect ratio (UW) is kept constant. The drive voltage can be reduced by thinning the flexures and/or reducing the gap, but within the limit of fabrication, the calculated drive voltage is still unattractively high.

As such it is highly desirable to fabricate a spatial light modulator that overcomes foregoing shortcomings associated with the prior art for the holographic display applications.

### SUMMARY OF THE INVENTION

Various aspects of the present invention relate to the design of a low-power electrically actuated surface micromachined MEMS spatial light modulator (SLM) with high reflectivity, high switching speed, high diffraction efficiency, high fill-factor and low surface adhesion to the substrate.

One aspect of the present invention provides a micromirror device comprising: a substrate; a top or upper (where “top” or “upper” means “in the direction away from the substrate”) electrode above and parallel with a surface of the substrate and having a reflective surface applied directly to the upper electrode; a plurality of posts on the substrate under the corners of the upper electrode and having distal ends spaced apart from an underside (where “bottom,” “lower,” or “under” means “in the direction towards the substrate”) of the upper electrode; a respective plurality of flexure arms, each extending from a distal end of a respective one of the posts, under and spaced apart from a side portion of the upper electrode, to a free end; a respective plurality of anchors, each extending from a respective one of the distal ends of the flexure arms away from the substrate, and joining the upper electrode directly to the flexure arms; and a lower electrode on the substrate under the upper electrode.

In an embodiment, the posts and flexure arms being within the volume defined by projecting the top electrode perpendicularly towards the substrate, so that when an array of devices are illuminated perpendicularly, no light directly reaches the posts or flexure arms without being first intercepted by the top electrode (or by a reflective or absorptive surfacing on the top electrode), and the adjacent devices can be very closely spaced, because no space between the top electrodes of adjacent devices is occupied by posts or flexure arms.

In an illustrative embodiment of the present invention, flexures are concealed in a cavity 301 beneath a top reflective mirror. With this design, a fill-factor on the order of 83-95% is achievable. Flexures that are concealed, so that they do not contribute to unwanted diffraction of light, can make possible a high contrast ratio. The fill-factor is the percentage of the total SLM area that is occupied by pixels. A high fill-factor is desirable because the unoccupied percentage, representing the gaps between the pixels, is area that will at least wastefully absorb light, and at worst reflect light in undesired directions, reducing image sharpness and contrast.

According to another embodiment of the present invention, flexures are supported on posts that work like natural stops, thus help preventing stiction issues that could occur in some previous devices when the two electrodes contact each other, even through a passivation layer. Unlike DMD, the natural stops can be at the same potential as the top electrode, and the gap (z₀) between the stop and the top electrode can be smaller than the gap (g) between the bottom electrode and the top electrode. Those features enable the problem of stiction (either due to capillary action or dielectric charging) to be reduced or even completely eliminated.

According to another embodiment of the present invention, reflective mirrors are directly attached to the top electrode, or even formed by the top surface of the top electrode. Direct attachment of the reflective mirror onto the top electrode with support on four sides makes possible lower mass and higher optical flatness than the DMD and BU designs. While the optically flat surface is important for light to be diffracted symmetrically in all direction, lower mass is required for high out-of-plane natural frequency.

According to another embodiment of the present invention, two different types of MEMS SLMs are proposed: a) Analog MEMS SIM and b) Binary MEMS SLM. As the name suggests, Analog MEMS SIN works in analog fashion. In one embodiment, the gap (zₙ) between any stops and the resting position of the top electrode provides up to 153 nm of travel distance (λ/4 for red light). Depending upon the drive voltage (normally operated above the pull-in voltage), the top electrode can be positioned anywhere between 0 to 153 nm, thus allowing the selection of any wavelength in the visible spectrum. This way any pixel in a 2D array MEMS SIM can be programmed for red (R), green (G) and blue (B) color light. In one design, the mirror element in Analog MEMS SLM consists of sputtered aluminum that provides more than 90% of reflectivity.

The binary MEMS SLM, on the other hand, works in binary mode. Each mirror has λ/4 travel distance tailored for a respective one of R, G, B color light, and set by fixed end stops. Since the gap (z₀) between the top electrode and the end stops is greater than the pull-in distance (z_{P}), fixed drive voltage greater than or equal to pull-in voltage (V_{P}) is applied to move the top electrode by λ/4. In Binary MEMS SLM, the R, G, B pixel mirrors are coated with dichroic band-pass filters that consists of multilayered thin-film stack of dielectric materials such as TiO₂ and SnO₂. Thus, each mirror element reflects only light of its correct color.

The top electrode, or a reflective top surface of the top electrode, may comprise or consist essentially of Al, or Al alloyed with one or more elements selected from the group consisting of Si, Cu, Ti, Cr, other transition metals, silicon, polysilicon, and their possible combinations.

The top electrode may consist essentially of an aluminum alloy selected from the group consisting of: Al with 1-2% Si; Al with 0.5-4% Cu; Al with 1% Si and 0.5% Cu; Al with 2.0% Ti and 1.0% Cu; and Al with 2.0% Cr and 1.0% C, all percentages by mass.

The device may further comprise, on top of the upper electrode, a high reflectivity metal thin-film, which comprise or consist essentially of one or more of Al, Ag, Au, Cu, Ni, Pt, Rh, to reflect the light in visible spectrum.

The device may further comprise, on top of the upper electrode, a dichroic filter and a Ni—P alloy or other absorber between the upper electrode and the dichroic filter to selectively reflect a narrow band of red, green or blue color light and absorb the remaining visible wavelengths. The dichroic filter may comprise alternating layers of higher and lower refractive index (n) materials. At least one of the alternating layers may be selected from the group consisting of SiO₂, Al₂O₃, ZnS, TiO₂, MgF₂, HfO₂, Sc₂O₃, ThF₄, Yb₂O₃, ZrO₂, and Ta₂O₅.

The light phase modulator may comprise an array of MEMS SLMs, where the top electrode of every SLM is coated with a thin metallic film, and the array is a 2D array consisting of identical and closely packed pixels in both axial directions of the 2D array.

The light phase modulator may comprise an array of MEMS SLMs, where the top electrodes of the SLMs are coated with dichroic filters, preferably backed by an Ni—P alloy or other absorber, and the array is a 2D array consisting of an array of closely packed red, green and blue pixels arranged in cyclically alternating fashion in a column, where the “column” is the direction of the 2D array that corresponds to the vertical direction of the viewer's head in an actual or intended configuration in use.

According to another aspect of the present invention, the MEMS SLM is fabricated using a low-temperature surface micromachining process directly on top of CMP (chemical mechanical polishing) planarized CMOS/TFT backplane 106. Fabrication of MEMS SLM is multi-step metal-polymer MEMS (MPM) process that includes low-temperature (<300° C.) sputtering and PECVD process for metal and dielectric, thin-films deposition, and polymer as a sacrificial layer. CMP is critical to some embodiments of the fabrication of an MEMS SLM, in which CMP is used not only for planarizing the surface for subsequent processes, but also to tweak the thin film to a predetermined thickness, such as in defining stop heights and the gap. From a packaging standpoint, and also because of the small pixels (large pitch number) needed for holographic displays, monolithic integration of a MEMS SLM with a TFT/CMOS backplane is preferred over conventional flip-chip bonding using indium micro-bumps, which results in a comparatively larger pixel footprint and is limited to smaller pitch. The present invention includes this and other methods of fabricating the MEMS SLM.

One aspect of the invention provides a method of fabrication of a spatial light modulator, or of an array of spatial light modulators, which may comprise one or more MEMS SLMs according to an aspect of the invention, comprising forming a plurality of sacrificial layers and a plurality of conducting levels. The method may use one or more of low-temperature processing, stress release mechanism, chemical mechanical polishing.

One embodiment of the method of fabrication comprises forming a plurality of conducting levels where each level has a distinct height above the substrate.

One embodiment of a method comprises two sacrificial steps, each forming a space below a subsequent structural level, to define a maximum travel distance (z₀) for the top electrode and an electrostatic gap determining an operating voltage (V) for electrostatic actuation.

Embodiments of the method of fabrication use low temperature processing, typically below 300° C., and/or sputtering, and/or a PECVD process for metal and dielectric thin-film deposition, and/or polymer or low-stress oxide as a sacrificial layer.

Embodiments of the method of fabrication comprise using chemical mechanical polishing to planarize the surface and/or tweak the thin film to a predetermined thickness. The predetermined thickness may be used to define stop heights and/or the electrostatic gap.

In an embodiment of the method of fabrication, a stress release mechanism comprises cooling the substrate temperature during the deposition process.

Embodiments of an MEMS SIM according to the invention provide a high contrast and high fill-factor phase-only spatial light modulator for holographic and interferometric applications.

This SUM can modulate the phase of the light to generate 3D ghost-like color holographic images by using electrostatically actuated reflective mirrors and color filters.

### BRIEF DESCRIPTION OF THE DRAWINGS

The above and other aspects, features and advantages of the present invention will be apparent from the following more particular description thereof, presented in conjunction with the following drawings. In the drawings:

FIG. 1 is a perspective view of one embodiment of a MEMS SUM in accordance with the present invention.

FIG. 2 is Side view of the MEMS SLM of FIG. 1.

FIG. 3 is the perspective view from below of a top electrode of the MEMS SLM of FIG. 1, showing cavities in the bottom side where the posts and flexures fit.

FIG. 4 is a perspective view of an un-actuated MEMS SLIM.

FIG. 5 is a perspective view similar to FIG. 4, showing an actuated MEMS

FIG. 6 is a perspective view of a row of Analog MEMS SLM elements, one of them actuated.

FIG. 7 is an enlarged view of a detail from FIG. 6.

FIG. 8 is a perspective view of a row of Binary MEMS SLM elements, one of them actuated.

FIG. 9 is an enlarged view of a detail from FIG. 8.

FIG. 10 is a top view of a 2D array of Binary MEMS SLMs,

FIG. 11 is a graph of transmittance against wavelength for a green-color dichroic mirror.

FIG. 12 is a 3-D graph of transmittance against wavelength and incidence angle for a similar mirror.

FIG. 13 is a flowchart.

FIG. 14 is top view of a substrate of the MEMS SLM of FIG. 1 at an early stage of manufacture of the substrate.

FIG. 15 is a view similar to FIG. 6, after filling the vias with thick aluminum.

FIG. 16 is a top view of the substrate of FIG. 15, after adding a bottom electrode and filling the remaining vias with Al.

FIG. 17 is a top view of the substrate of FIG. 16, after a passivation layer has been applied on top of the bottom electrode.

### DETAILED DESCRIPTION OF THE INVENTION

A better understanding of various features and advantages of the present invention will be obtained by reference to the following detailed description of embodiments of the invention and accompanying drawings, which set forth illustrative embodiments that utilize particular principle's of the invention.

Examples of the design and fabrication of MEMS spatial light modulators (SLM) featuring high reflectivity, high switching speed, high diffraction efficiency, high fill-factor, lox surface adhesion and low chive voltage for holographic display applications are presented.

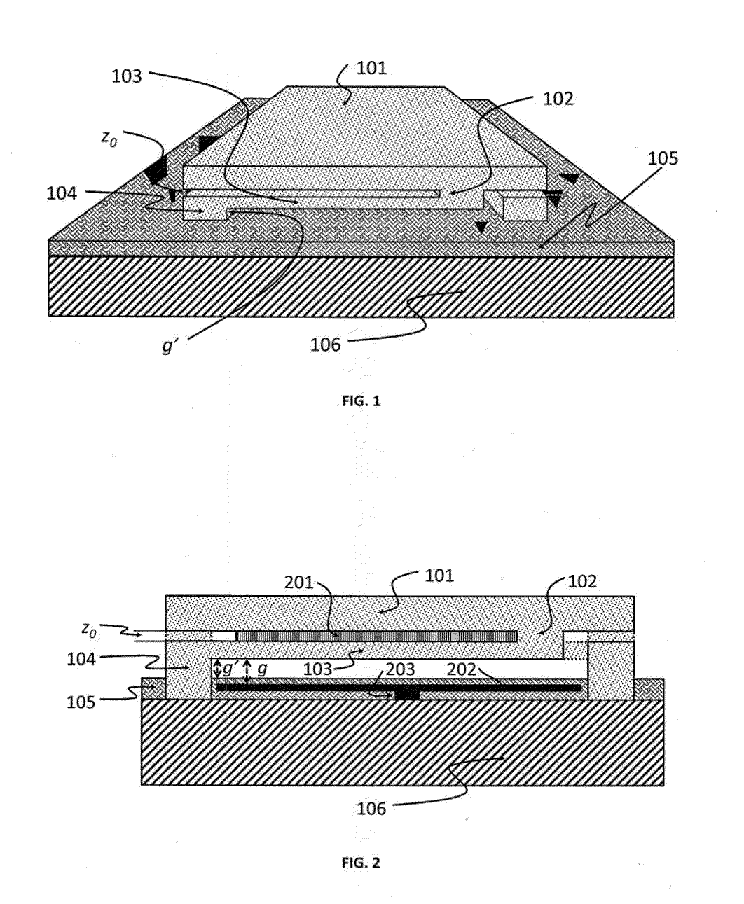

Referring now to the accompanying drawings, and initially to FIGS. 1-2, one example of a MEMS SLM consists of a square membrane (referred to herein as ‘top electrode’ 101) supported by four flexures. Each flexure comprises an upright post 104 under one corner of the top electrode 101, From the top of the post, a horizontal arm 103 extends parallel to one side of the top electrode 101, almost to the next corner. At the distal end of the flexure arm 103, the top electrode 101 is supported on an anchor 102, so that there is an initial clearance (z₀) between the flexure arm 103 and the underside of the top electrode 101. The posts 104 are mounted on and electrically connected to, a substrate or backplane 106, which comprises TFT/CMOS (thin film transistor/complementary metal oxide semiconductor) control electronics (not shown in detail). The control electronics may be conventional and, in the interests of conciseness, are not further described here. The surface of the substrate is covered with a nitride passivation layer 105, which may be formed by plasma enhanced chemical vapor deposition (PECVD). A bottom electrode 202 is embedded in the nitride layer 105 beneath the top electrode 101. The bottom electrode 202 is passivated with the PECVD nitride layer 105 both from top and bottom side. It is connected to the substrate through contact metal 203. In operation, the device is electrostatically actuated by attraction between the top 101 and bottom 202 electrodes. The passivation 105 on the top side of the bottom electrode 102 protects the device from accidental short-circuiting of the top 101 and bottom 202 electrodes. The bottom passivation of the bottom electrode 202 isolates the MEMS SLM from the CMOS/TFT backplane control electronics in the substrate 106. The posts 101 supporting the top electrode 101 are connected to the substrate 106 through vias 1401a, 1401b, 1401c, 1401d, in the passivation layer 105, as illustrated in FIG. 14-17 and described in more detail below. The contact metal 203 of the bottom electrode 202 is similarly connected to the substrate 106 through via 1401e in the passivation layer 105.

The actuator deflection, that is to say, the vertical movement of the top electrode 101, the purpose of which will be explained below, can be determined by balancing an electrostatic force P generated by applying a voltage V between the top 101 and bottom 202 electrodes with the mechanical restoring force Fₘ resulting from the stiffness of the flexure arms 103. The electrostatic force depends upon the actuation voltage (V and the device geometry. It can be calculated by taking the gradient of stored energy between the top 101 and bottom 202 electrodes and defined as

Fₑ=εAV²/2(g−z)², (1)

where
ε is the electrostatic permittivity of the space between the two electrodes,
A is electrode area,
g is initial gap and
z is displacement.

The electrostatic permittivity e may be approximated to the electrostatic permittivity s₀ of free space, because the passivation layer 105, which may have a significant relative permittivity, is typically only 50 nm thick, so most of the gap g is air fair gap width g′).

Mechanical restoring force is applied to the movable top electrode 101 through the four anchored flexure arms 103. Assuming the posts 104, the anchors 102, and the top electrode 101 to be approximately rigid, so that the flexure arms 103 curve in an S-shape with both ends remaining horizontal, the mechanical restoring force due to the flexure arms 103 can be given by the equation for a fixed-guided rectangular cantilever beam as

Fₘ=4(Ewt³/l³)z, (2)

where
E is Young's modulus for the material of the flexure arm 103, and
w, t and l are respectively the width, thickness and length of the flexure arm 103.

Balancing Fₘ and Fₑ results in actuation voltage as a function of displacement and geometrical and material parameters of the MEMS SLM as defined below:

$$V = \sqrt{\frac{8 {Ewt}^{3}}{ɛ {Al}^{3}} {z ( g - z )}^{2 }} \qquad ( 3 )$$

This is an important equation for designing the present MEMS SLM.

As may be seen from the above Equation (3), there is a local maximum of V at z=g/3, which is referred to as the “pull-in point.” The actuation voltage and displacement corresponding to the pull-in point are referred herein as “pull-in voltage (V_{P})” and “pull-in distance (z_{P})”. For lower values of V and z, z will increase as V increases, so the position of the top electrode 101 can be varied in an analog manner simply by varying V. The variation is not linear, but calculating the correct value of V is trivial with modern microprocessors. When the top electrode 101 descends towards the lower electrode 202 beyond the pull-in point, (V=V_{P} and z=z_{P}), the mechanical restoring force (Fₘ) no longer counteracts the electrostatic attraction (Fₑ) between the top 101 and bottom 202 electrodes, and the top electrode 101 snaps down until something stops it. Thus, with this SLM configuration, analog operation should in general be confined to the regime where V is below the pull-in voltage V_{P}, z is less than the pull-in distance z_{P}, and the physical spacing g−z of the top electrode 101 is above the pull-in point. Binary operation, in which the top electrode 101 is held against a solid stop when actuated, is more effectively implemented in the other regime, where V is above the pull-in voltage V_{P}, z is greater than the pull-in distance z_{P}, the physical spacing g-z between the top 101 and bottom 102 electrodes is below the pull-in point, and the top electrode snaps into position on the stops. It should be noted that due to the finite thickness (t′) of the passivation layer 105 above the bottom electrode 202, the height of the air space in the actuated MEMS SLM will be g′−z, where g′=g−t′.

For holographic, display one of the basic requirements is that the pixel must be diffractive. This can be achieved by reducing the area A in accordance with the general discussion and formula on page 3 of 25 of Ref. [7]:

p≧(4/λ)*sin(Θ/2) (4)

where
p is the pitch of the modulated light, measured in samples per unit length,)
λ is the wavelength of the light, and
Θ is the maximum angle of diffraction, which determines the available viewing zone/angle for the holographic image.

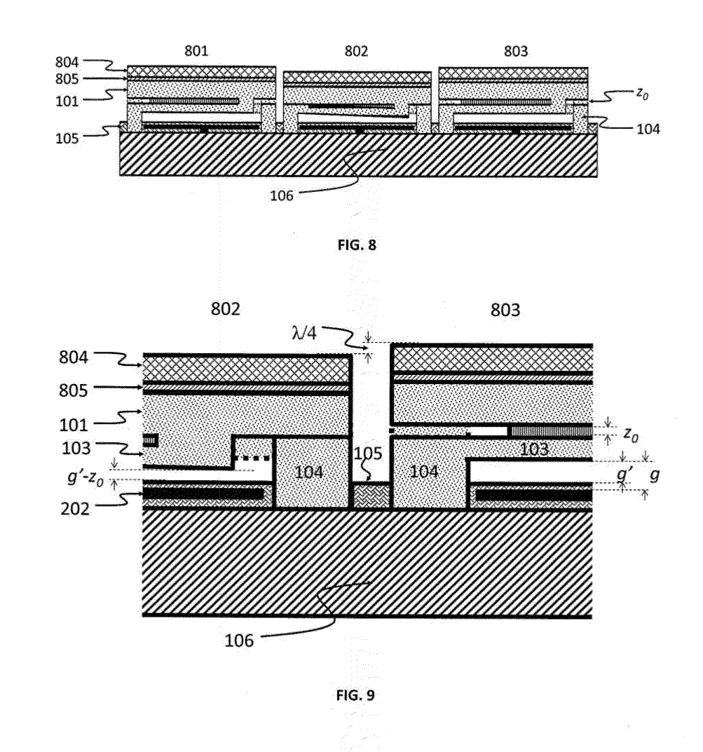

Thus, for a light of a given wavelength λ, the required pitch p increases with a Θ. Smaller pixels represent a larger pitch p, and thus a wider diffraction angle Θ. Smaller pixels not only are difficult to fabricate, but also require a larger voltage to actuate them (because they have a smaller area A). This can, however, be compensated by reducing the gap g and/or adjusting flexure arm 103 dimensions (especially the thickness t). Since the presently proposed MEMS SLM is a phase-only device where the pixels move by λ/4 amount, the gap g must be defined to accommodate the pixel travel distance (z) taking into account whether the pixel is operated above (Analog MEMS SLIM [FIGS. 6-7]) or below (Binary MEMS SLM [FIGS. 8-9]) the pull-in distance (z_{P}).

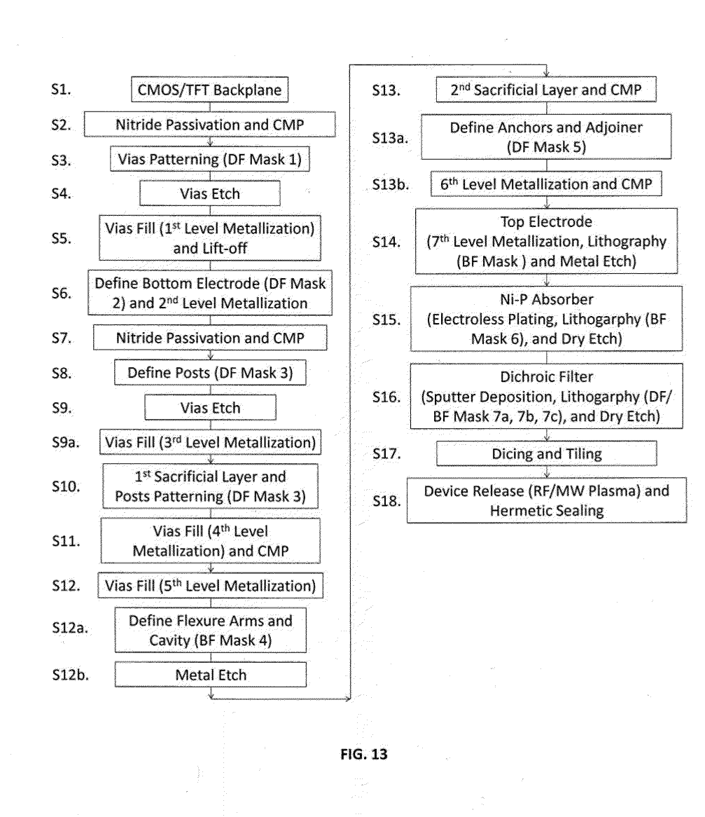

Binary operation requires a travel of λ/4=153 nm for red light, so the gap (g) is set slightly greater than that, typically 250 nm, to avoid the top electrode 101 and the exposed surface of layer 105 contacting one another. Analog operation with z<g/3 requires g>460 nm, typically 500 nm. Given these design guidelines and operating constraints, with a pixel size of 20 μm×20 μm, and flexure 103 length l, width w, and thickness t are 13, 2 and 0.5 μm, respectively, and using the aluminum alloy of FIG. 13, Step S12 below for flexure arms 103, for example, binary operation at a gap (g) of 0.25 μm requires about 5V to drive the SLM by λ/4 amount. Analog operation with g=0.5 μm requires a correspondingly larger voltage of about V=18V.

Regarding the ability of these pixels to diffract light—at a nominal wavelength of 540 nm, 20 μm×20 μm pixels diffract the light by 1°. If the pixel size is reduced to 10 μm×10 μm, the angle of diffraction increases to 1.5°. For display applications such a small angle of diffraction implies a narrow and restricted viewing zone. However, if the narrow viewing zone is combined with eye-tracking technology as described in Ref. [8], it is possible to generate 3D holograms with a wide effective field-of-view.

As far as switching speed is concerned, switching of the present MEMS SLM can happen extremely fast, i.e., in microseconds. This is achieved by selecting the proper device geometry and integrating the reflective mirror directly on top of the top electrode. Unlike TI's DMD and BU's design discussed above, direct attachment of the reflective mirror onto the top electrode, without an intervening post, has benefit of low mass and optical flatness. While the optically flat surface is important for light to be diffracted symmetrically in all directions, lower mass is required for high out-of-plane natural frequency. From both finite element analysis (FEA) and modeling the assembly of top electrode and flexures as a simple mass-spring system, the proposed geometry yields a natural frequency >500 KHz. For video display without interlacing, 60 Hz operation frequency is a minimum requirement, and 120 or 240 Hz is preferred for high speed display. This is effectively tripled when one-bit color is used. For 8-bit color, the physical SLM is switched 256 times per frame per color, so that a data rate of 2̂8*3*60 Hz, i.e., 46 kHz per pixel is then required. Wide bandwidth offered by the MEMS SEM meets the requirements for high speed video display. Wide bandwidth is also a plus for operating the pixels at a fixed actuation voltage. Even though the frame rate is fixed, every pixel in 2D array is actuated at variable duty cycle to represent color shades. Many modern TVs have even user selectable refresh rates. For this reason also, wide bandwidth is desirable. Wide bandwidth provided by the MEMS KM allows these pixels to be operated at fixed voltage. This simplifies the drive electronics.

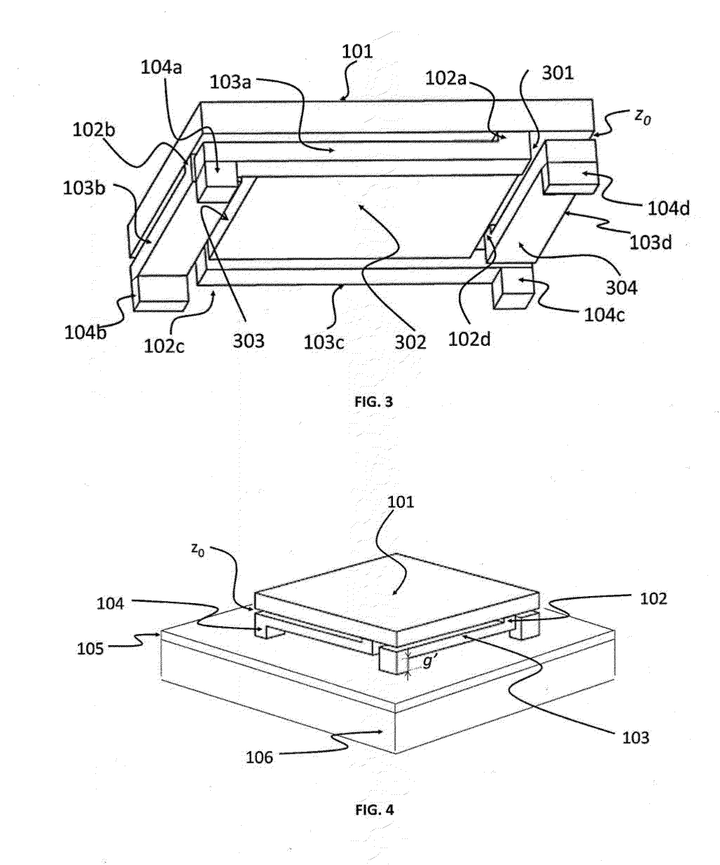

Referring now also to FIG. 3, in the MEMS SLM of FIGS. 1 and 2, the flexures 103a, 103b, 103c, 103d are concealed in a cavity 301 beneath the top electrode 101. The bottom side of the top electrode 101 is symmetrically thinned (shown with cavity side wall 303) at its periphery to accommodate flexure arms 103a, 103b, 103c, 103d. One end of each flexure arm is attached to the bottom of the top electrode through a respective anchor 102a, 102b, 102e, 102d. The opposite end of each flexure is attached to a post 104a, 104b, 104c, 104d that is mounted on the substrate. Flexures 103a, 103b, 103c, 103d, anchors 102a, 102b, 102c, 102d and posts 104a, 104b, 104e, 104d are electrically conducting and activated through the backplane control electronics 106. The middle portion of the bottom 302 of the top electrode, the portion apart from and surrounded by the cavity 301, is at the same level as bottom side 304 of the flexure arms when the SLM element is not activated. One advantage of concealed flexures is the high fill factor. With this design, a till factor as high as 83-95% is achievable, together with a low drive voltage. For example, 20 μm×20 μm pixel at 1 μm separation between pixels has a fill factor of 91%, whereas 10 μm×10 μm pixels at the same 1 μm separation will have 83% fill-factor. As the separation between the pixels is reduced to 0.5 μm, the fill-factor increases to 95% and 91%. In general, fill-factor is related to the smoothness of the image at a given viewing distance. In holographic display since the 3D image is the result of interference of diffracted light, closely packed pixels are highly desirable. MEMS SLM as proposed in this invention fully satisfies this requirement.

Another benefit of the device shown in FIG. 3 is that a high contrast ratio can he achieved for the holographic image. MEMS SLMs reported in the prior art have the flexures present in the inactive area between the pixels. This results in unwanted and uncontrolled scattering of the light from the flexures. In the present embodiment, since the flexures 103 are concealed below the top electrode 101, the possibility of unwanted light scattering can be almost completely eliminated. It is, therefore, possible to achieve high contrast ratio holographic display.

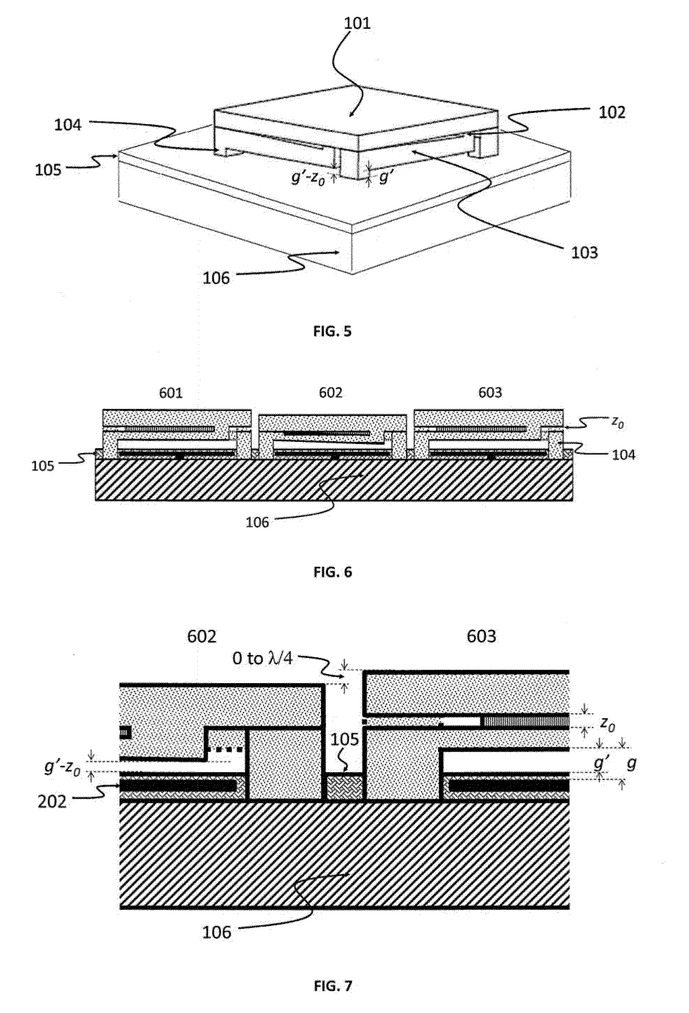

From the operational standpoint, the present MEMS SLM has two major design considerations: the gap (z₀, setting the maximum travel) between the top electrode 101 and flexures 103, and the gap (g, affecting the electrostatic force) between the top 101 and bottom electrodes 202. Referring to FIGS. 4-5, in which FIG. 4 shows an un-actuated SLM according to FIGS. 1-3 and FIG. 5 shows an actuated SLM, while g determines actuation voltage (V) and governs the operating point of the device above or below the pull-in distance, z₀ allows the top electrode 101 to move by a fixed amount to achieve precise phase shift. Total travel distance of the top electrode 101 is equal to λ/4 of the illuminated light. For full NTSC color space gamut, λ/4 travel distance for R, G, B color lights is on the order of 153 nm, 135 nm and 118 nm respectively. If the gap between top 101 and bottom 202 electrodes is g, pull-in occurs when top electrode travels down by one third of g. By proper choice of g, MEMS SLM can be operated above or below the pull-in point. These modes of operations are described in more detail below.

An innovative aspect of the design shown in the drawings is that the posts 104 onto which the flexures 103 are supported work like natural stops for the top electrode 101. Unlike DMD, these natural stops are at the same potential as the top electrode 101, because the torsion arm supports are also the electrical connections from the control electronics 106 to the top electrode 101, and the travel distance (z) is smaller than the gap (g) between the top and bottom electrodes. Because of these differences, the problem of stiction (either due to capillary action or dielectric charging) can be greatly reduced, or even completely eliminated. As shown in FIG. 5, when the SLM is actuated to its fullest extent, an air gap of (g′−z₀) is left between the bottom of top electrode and the substrate. This further prevents the device from stiction.

According to an aspect of the present invention, two different types of MEMS SLMs are proposed: a) Analog MEMS SLM and b) Binary MEMS SLM.

Analog MEMS SUM, as the name suggests, works in analog fashion. Referring to FIGS. 6-7, in one embodiment of an Analog MEMS SLM, the mirror element consists of a coating that is highly reflective throughout the visible spectrum, such as an aluminum coating (reflectivity >90%). Gap z between the top electrode 101 and posts 104 has up to 153 nm of travel distance, which is quarter of the wavelength for red color light. Gap g is set such the device operates above the pull-in point. For g=500 nm, pull-in distance (z_{P}) will be 167 nm which is greater than the allowable travel distance (z₀), hence the device operates above the pull-in point. Depending upon the drive voltage, top electrode 101 can be positioned anywhere between 0 to 153 nm either in analog fashion (for full color) or in steps. For example, the drive electronics may be preset for mirror positions of 153 nm, 135 nm and 118 nm for discrete R, G, B color, with the inactive position at 0. Shown in FIG. 6 is an array of three Analog MEMS SLM (601, 602, 603) in which the middle SLM 602 is actuated. FIG. 7 shows enlarged view of relative position of 602 and 603. In this example, since the top electrode 101 has travelled to its maximum distance (λ/4 of red color light), relative phase shift between the red color light reflected by these pixels is equal to a half-wavelength (i.e. 180 degrees). This causes destructive interference between the phase-shifted and unshifted reflected rays in the straight-ahead direction.

One embodiment of Binary MEMS SLM (FIGS. 8-9) works in binary mode and has λ/4 travel distance precisely tailored for each R, G and B color light. Each pixel has an integrated dichroic band stop filter 804 and absorber 805 for reflecting R, G, B color light. This effectively acts as a narrowband reflector, because light in the filter stop-band is reflected, whereas all other light is transmitted to the absorber. Gap g is set such the device operates below the pull-in point. For g=250 nm, pull-in distance (z_{P}) will be 83 nm which is smaller than the allowable travel distance (z₀), hence the device operates below the pull-in point. Unlike Analog MEMS SLM, Binary MEMS SLM is actuated by applying a fixed drive voltage equivalent to the pull-in voltage (V_{P}) or a little more. When the pull-in voltage is applied mechanical spring force can no longer counter the electrostatic force, consequently top electrode 101 snaps down but before it hits the substrate it is stopped by the posts 104. Depending upon the travel distance, a binary phase modulation can be obtained for each color. Shown in FIG. 8 is an array of three Binary MEMS SLM 801, 802, 803 in which middle SLM 802 is actuated. FIG. 9 shows enlarged view of relative position of 802 and 803. In this example, since the top electrode 101 has travelled to its maximum distance (λ/4), relative phase shift between the light reflected by these pixels is equal to a half-wavelength (i.e. 180 degrees).

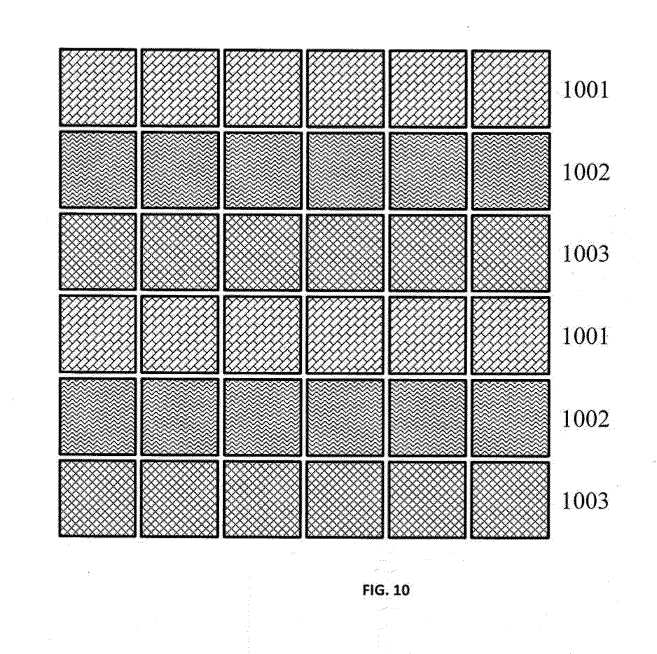

In an embodiment of Binary MEMS SUM, since separate pixels are assigned to R, G, B color lights, the 2D array consists of a repeating sequence of R 1001, G 1002, B 1003 pixels, for example, in rows as shown in FIG. 10. In each horizontal row, the pixels are identical. Since the human observer generally moves horizontally, this scheme provides better resolution in the horizontal direction than the vertical direction. The 2D array of Analog MEMS SEM on the other hand consists of identical and closely packed pixels in both horizontal and vertical axis. Since the Analog MEMS SLM can be programmed for any color, 2D display is expected to have better resolution in both directions. However, in terms of color contrast, Binary MEMS SLM because of the dichroic filters 804 is much superior. Also, Binary MEMS SLM Device is illuminated with a single white light source, while the Analog MEMS SLIM requires R, G, B light sources working in sync with R, G, B color separated image frames. In terms of drive-voltage Binary MEMS SLIM again outperforms the Analog MEMS SLM.

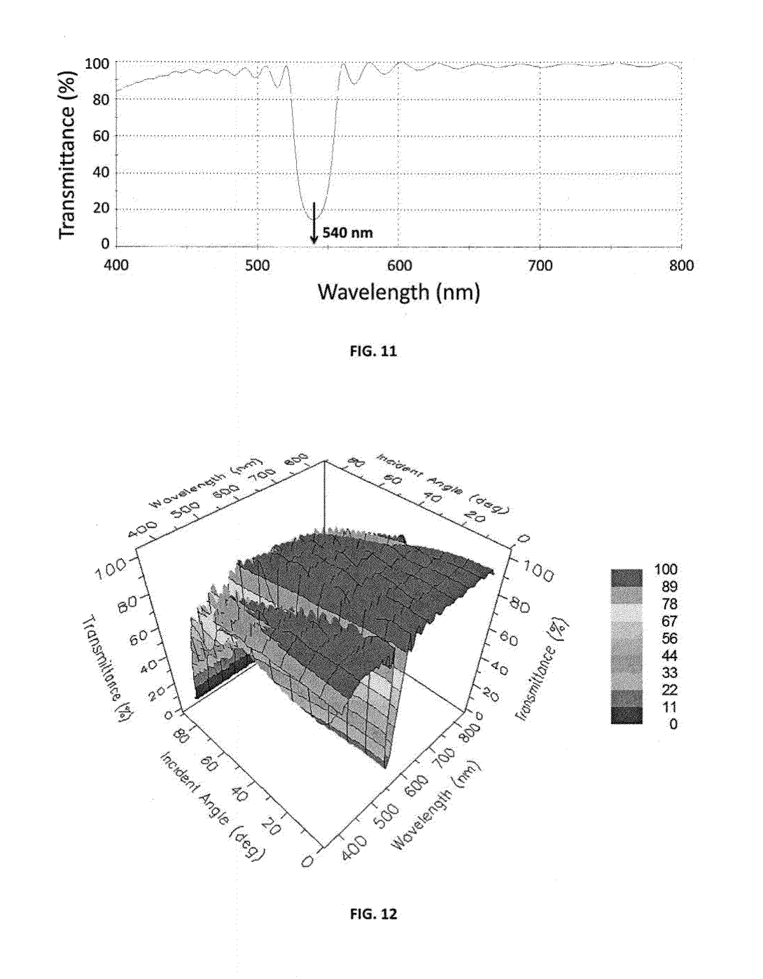

Referring to FIGS. 11 and 12, an example of dichroic filters 804 used in Binary MEMS SLM are dielectric thin-film stacks to selectively reflect R, G, B color and transmit the others with high degree of efficiency. Dielectric mirrors select the wavelength by constructive and destructive interference of light reflected off thin layers of interleaved high and low refractive index (n) materials. By judiciously selecting the type and thickness of the dielectric layers, a very narrow band of wavelength can be selected at a high reflectivity. The transmittance plot shown in FIGS. 11-12 is a representative example of green color filter modeled using Essential MacLeod, multi-layer thin film optical design tool, see Ref [9]. Because in the present embodiment the dielectric filter is being used as a mirror, the minimum in the transmittance curve corresponds to the desired maximum in the reflectance. A stack of fifty five alternate layers of TiO₂ (n=2.35) and SiO₂ (n=1.46) having a total thickness of 3.3 μm transmits ,almost all the colors except the 540 nm green light. With this multilayered structure, reflectivity as high as 85% is achievable. This can, however, be further maximized through optimization and/or choosing other possible materials combinations. Common materials for dielectric mirrors are, but not limited to (n=2.35), Al₂O₃ (n=1.62), ZnS (n=2.2), TiO₂ (n=235), MgF₂ (n=1.37), HfO₂(n=1.98), Sc₂O₃ (n=1.9), ThF₄ (n=1.35), Yb₂O₃ (n=1.8), ZrO₂(n=1.95) and Ta₂O₅(n=2.1). Essential MacLeod has a list of other materials in its library that can also be explored to design the filters. The skilled person can select suitable pairs of materials for a specific implementation.

In order to prevent back-reflection of the transmitted wavelengths, the dichroic filters 804 are backed-up with an absorptive coating 805. Ultra-black film of nickel-phosphorus (Ni—P) alloy is one such material that can be used as an absorber. As reported in Ref. [10], Ni—P exhibits excellent low reflectance (<0.1%) in the visible and near IR regions. Alternatively, a quarter wavelength resonance cavity tuned to absorb the full visible spectrum can also be employed. Design of quarter wavelength resonance cavity is similar to design of the multi-layered reflective coating but the order of refractive index is reversed, see Ref. [11].

One preferred embodiment of the manufacturing process of the phase-only MEMS SLM of FIGS. 1-10 is shown in FIG. 13. In this embodiment, the MEMS SLM is fabricated using a surface micromachining process directly on top of prefabricated CMOS/TFT backplane 106. The backplane contains electronic circuitry and electrical connections necessary to drive the pixels correctly. From a packaging standpoint and also because of the small pixels required for holographic displays, monolithic integration of MEMS SLM with backplane electronics is preferred. This demands low-temperature micromachining process for fabricating the MEMS SLM, to avoid over-heating the electronic structures that may already have been created. The scheme proposed in the flow chart of FIG. 13 is multi-step metal polymer MEMS (MPM) process that includes low-temperature (<300° C.) sputtering and PECVD process for metal and dielectric thin-films deposition, and polymer as a sacrificial layer. Chemical Mechanical Polishing (CMP) is critical to fabrication which is used not only for planarizing the surface for subsequent processing but also tweaking the thin film to predetermined thickness such as in defining the gap (g) for electrical actuation, stop heights (g′) and the maximum travel distance (z₀).

In Step S1, the CMOS/TFT Backplane is fabricated, as discussed above.

In Step S2, the manufacturing process starts by depositing a dielectric layer 1402 (see FIG. 14) on the prefabricated backplane 106. As the fabricated backplane surface has excessive topography it must, therefore, be planarized to avoid print-through in subsequent device layers. To do so first a thick dielectric layer (low stress Si₃₊ₓN_{4-y}) 1402 is deposited using SiH₄ and NH₃ feedstock in a Plasma Enhanced Chemical Vapor Deposition (PECVD) reactor excited at 350 kHz and 13.65 MHz below 400° C. Nitride coated TFT/CMOS electronics is subsequently planarized with conventional CMP (chemical mechanical polishing) using, colloidal silica (SiO₂) or ceria (CeO₂) based slurry until RMS flatness of 1-5 nm is achieved and nitride thickness is reduced down to 2 μm. Because the quarter wavelength difference between R, C, and B color light (λ_{R}-λ_{G}, λ_{G}-λ_{B}) is only 17.5 nm, a high degree of inter and intra pixel optical flatness is required to avoid false interference of the diffracted light. Thick dielectric top layer is required for electrical isolation of the backplane from the actuation voltage applied across the top 101 and bottom electrodes 202 of the MEMS SLM.

In Step S3 vias are opened into the planarized nitride passivation layer 1402 for contact to the backplane control electronics 106. This includes photolithographic patterning using dark field (DF) Mask Set 1 followed by RIE (reactive ion etching) in CHF₃/O₂ ambient [Step S4]. Five sets of vias 1401a, 1401b, 1401c, 1401d, 1401e are opened for each pixel—four 1401a, 1401b, 1401c, 1401d for the top electrode 101 contacts and one 1401e which is in the middle for the bottom electrode 202, as shown in FIG. 14. Vias 1401a, 1401b, 1401c, 1401d are in positions corresponding to the four posts 104a, 104b, 104c, 104d that will support the flexure arms 103a, 103b, 103c, 103d.

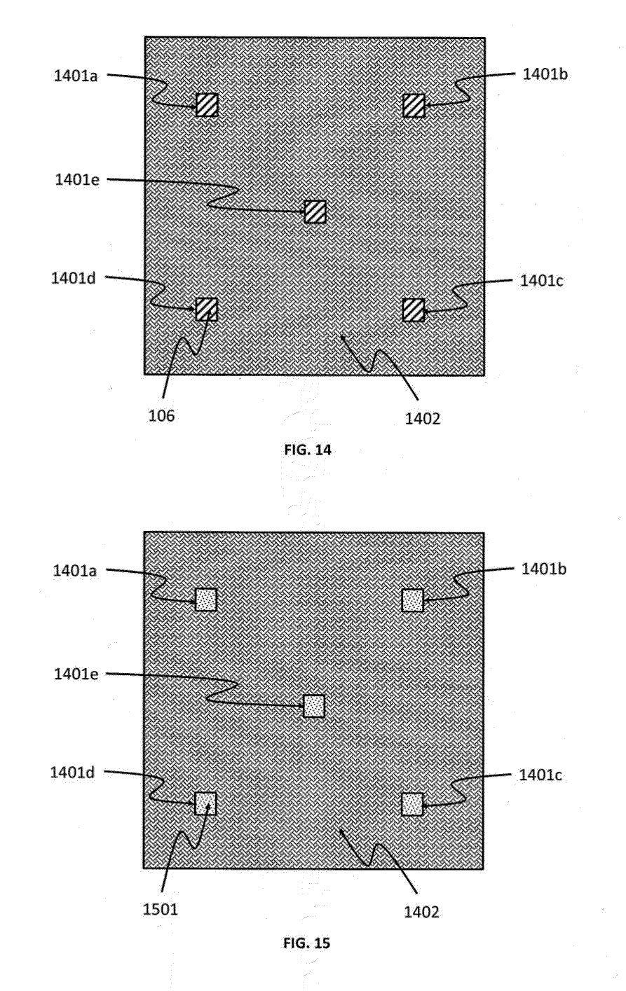

In Step S5, a thick 2 μm aluminum (Al) contact 1501 is deposited followed by lift-off to fill the openings, as shown in FIG. 15. Physical vapor deposition (PVD) based on argon plasma is used to sputter the atoms off the target to deposit Al on the substrate. Sputtering is chosen as a method of contact metal deposition as it allows not only low-temperature deposition (down to room temperature) but also offers wide range of processing conditions (partial pressure, RF power/DC bias and substrate temperature) required for further metallization in subsequent steps. Metal to be deposited can be had directly pure Al target or Al alloy such as Al W/1-2% Si, Al w/0.5-4% Cu, Al w/1% Si/0.5% Cu. Al alloy is, however, preferred for reliable electrical contacts and metal lines. For this reason also, sputtering is chosen as a method of metallization rather than the evaporation which has difficulty producing well controlled alloys due to differences in vapor pressure between the two materials.

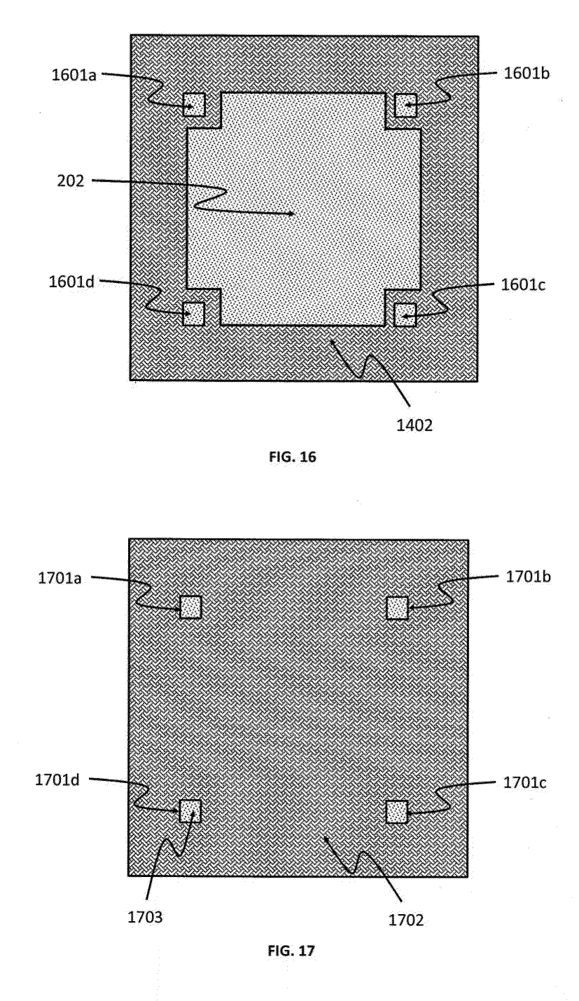

A second level of metallization [Step S6] includes a square shaped bottom electrode 202 on top of the middle Al contact pad 1501 (which in this embodiment also forms the contact metal 203) deposited in previous steps [Step S3-S5] inside the middle via 1401e. This way the bottom electrode 202 is electrically connected to the backplane electronics 106. Included with this level are four additional Al patches 1601a, 1601b, 1601c, 1601d on top of the previously deposited Al 1501 inside the corner vias 1401a, 1401b, 1401c, 1401d. This is implemented by photolithographic patterning using DF Mask Set 2 followed by sputter depositing 100 nm of Al alloy. FIG. 16 shows the substrate after lift-off the photoresist and the metal 202, 1601a, 1601b, 1601c, 1601d above it. In Step S7, the bottom electrode 202 is passivated with a thin (˜50 nm) nitride layer 1702 to avoid accidental short circuiting with the top electrode 101, FIG. 17. The direct deposition of thin nitride on top of 100 nm metal structures 202, 1601a, 1601b, 1601c, 1601d may result in print-through effect in overlaid structures. To avoid this, first a thick (˜0.25 um) PECVD nitride layer, as used in Step S2, is deposited and then the nitride layer is thinned down to a thickness t′=50 nm 1702 using CMP (Step S7). It should be noted that since the isolation layers 1702 in FIGS. 17 and 1402 in FIG. 14 are PECVD silicon nitride, they are, just for the sake of simplicity, represented as a single solid block 105 in FIG. 1 and FIG. 2.

A third level of metallization (Step S8-S9) includes contact pads 1703 that are in the same plane as the planarized nitride passivation layer 1702. To do this planarized nitride passivation layer 1702 is photolithographically patterned using DF Mask Set 3 aligned to four Al pads 1601a, 1601b, 1601c, 1601d fabricated in Step S6 (second level metallization). Exposed nitride in the developed area is now dry etched to open the vias 1701a, 1701b, 1701c, 1701d right on top of Al pads 1601a, 1601b, 1601c, 1601d . Next the wafer is sputtered with 150 nm Al alloy to fill the vias 1701a, 1701b, 1701e, 1701d. The wafer is then immersed into acetone and ultrasonically agitated to lift-off the unwanted metal and photoresist, leaving behind a completely planar surface (FIG. 17) onto which further structure can be built.

According to an embodiment of the present invention, the MEMS SLM architecture is built using sacrificial layers. Since there are two hanging structures at two different heights (z₀ and g′)—one for the flexures 103 and other for the top electrode 101, two layers of the sacrificial material are deposited.

A first sacrificial layer is deposited with a predetermined thickness (g′) (450 nm for Analog MEMS SLM and 200 nm for Binary MEMS SLM) on the surface 1702, 1703 of semi-fabricated wafer from FIG. 17. It should be noted that the top 101 and bottom 202 electrode structures in Analog, MEMS SLM and Binary MEMS SLM are physically separated by 450 nm and 200 nm of airspace, respectively, but the electrical gaps (g) for electrostatic actuation are 500 nm and 250 nm. This includes t′=50 nm thin nitride passivation layer as well as the air (g′). Keeping in view the low-processing temperature requirement and ease of the final release of the MEMS structure, the sacrificial layer used in the MEMS SLM is photoresist which can be deposited by spin coating. This resist layer is patterned (Step S10) with 2 μm square holes using DF Mask Set 3 aligned to the third level Al contact pads 1703. These holes serve as posts 104a, 104b, 104c, 104d for the attachment of flexures 103a, 103b, 103c, 103d in later stage.

A fourth level of metallization in now performed to realize posts 104a, 104h, 104c, 104d, Al alloy thicker than the resist thickness is deposited on the developed resist and then polished by CMP using pH balanced alumina (Al₂O₃) slurry until the etch process is naturally stopped by the resist (Step S11). This results in a planar surface for fabricating flexure arms 103a, 103b, 103c, 103d and bottom portion 302 of the top electrode that would eventually form the cavity 301. A 0.5 μm thick Al alloy, fifth level of metallization that define flexure thickness (t), is now performed on the planarized surface (Step S12). Next the photoresist mask is applied (Step S12a) and patterned (Step S12b) to define flexure arms 103a, 103b, 103c, 103d and cavity 301 using the bright field (BE) Mask Set 4. This followed by chlorine based (Cl₂/BCl₃) reactive ion etching (RIE) to anisotropically etch out the exposed Al.

Second sacrificial photoresist layer that defines the traveling distance (z₀) of the top electrode 101 is applied on top of the metal structures 302, 103a, 103b, 103c, 103d fabricated in Step S12. Coating of this surface with predetermined resist thickness (153 μm for Analog MEMS SLM, and 118, 135 and 153 μm for Binary MEMS SLM) results in excessive topographical effects due to comparatively larger thickness of the underlying metal structures 302, 103a, 103b, 103e, 103d. Same as in Step S2 and Step S7 this problem is alleviated by first coating the wafer with thick resist and then subjecting it to CMP for planarization and thinning to the desired z₀ thickness (Step S13). It should be noted that photoresist polishing rates are strongly dependent on the baking temperature. Depending upon the baking temperature, the polishing rate could range from as high as 7000 nm/min to lower than that of SiO₂ when baked at 240° C., so care should be taken to optimize the process not only to allow a well-controlled polishing rate but also to ensure that, the photoresist is easily sacrificed in the final release process. To planarize the photoresist, either alumina or resin-based slurry can he used. However, soft resist-based slurry is most suitable as it results in much better planarity as well as a low baking temperature, see Ref [12]. Once the resist is planarized to the target thickness (z₀), holes for the anchors 102a, 102b, 102c, 102d are patterned using DF Mask Set 5 (Step S13a) and filled with Al alloy, sixth layer of metallization (Step S13b), following the same process (fifth level of metallization and CPM) as used previously in Step S11. Along with the anchors 102a, 102b, 102e, 102d, an Al adjoiner 201 is also fabricated to couple the bottom of the top electrode 302 previously fabricated in Step S12 with the full-size top electrode 101 (Step S14). This increases the cavity height 303 to z₀+0.5 μm (flexure thickness, t).

According to an embodiment of the present invention, the top electrode 101 is made of Al alloyed with transition metals in one of the following compositions: Al-1.0% Cu, Al-2.0% Ti-1.0% Cu and Al-2.0% Cr-1.0% Cu, as reported in Ref. [13]. These Al films containing Cu, Ti, and/or Cr exhibit the same bulk reflectance (>90% in visible spectrum) as pure Al but have improved surface morphology (smaller grains with less pronounced surface roughness) and mechanical stability (hardness, elastic modulus, and tensile strength) which are highly desirable for the proposed MEMS SLM, especially Analog MEMS SLM. As described earlier, the Analog MEMS SLM top electrode serves as an opposite electrode for electrical actuation as well as a mirror. Al alloy not only provides mechanical rigidity to the top electrode 101 but also makes it comparatively easy to form a surface that is optically flat. Top electrode 101 for Analog MEMS SLM is fabricated (Step S14) by sputter depositing ˜1 μm thick layer of Al alloy on top of the planarized wafer with exposed metal anchors 102a, 102h, 102c, 102d and adjoiner 201 fabricated in Step S13. This is the-seventh level of the metallization process. A photoresist mask layer is now applied and exposed through BF Mask Set 6 to define the pixel area 101. This mask pattern is aligned such that the anchors 102a, 102b, 102c, 102d produced in previous step sit directly beneath the active area 101. The relationship is best seen in FIG. 3. The metal area exposed after developing the resist is anisotropically etched using chlorine based chemistry (Cl₂/BCl₃) in RIE reactor. This is the final fabrication step for Analog MEMS SLIM before the release step. The top electrode of Binary MEMS SLM is fabricated following the same process steps as used for Analog MEMS SLM but structurally the metal layer 101 is comparatively thinner (˜0.2 μm) in the Binary MEMS SLM. This is because the top electrode in Binary MEMS SLM has several additional layers of dielectric thin films 804 (as will be explained in Steps S15 and S16 below) to reflect the light, and those additional layers also provide mechanical rigidity to the top electrode.

According to one preferred embodiment of the present invention, color-selective light reflectivity in Binary MEMS SLM is achieved by dichroic filter 804 (dielectric thin-film stacks) with absorber 805 backing. As described above, each R, G, B color dichroic filter 804 has different sets of alternating thin-films of TiO₂ and SiO₂ which can be deposited in-situ in a dual-magnetron sputtering system that allows equipment to alternate the deposition of high and low refractive index materials without needing to change the target, thus provides consistent, repeatable rates of deposition with spectral performance close to the theoretical model. R, G, B filters are fabricated in sequential fashion (i.e. one after other by photolithographically masking the other two sets of pixels using DF Mask Set 7a, 7b, 7c) followed by reactive ion etching (RIB) to selectively and anisotropically etch out the unwanted material except on the pixels, which is again done in sequential fashion but with BF Mask Set 7a, 7b, 7c (Step S16). Common materials for dielectric mirrors 804 include, but are not limited to, SiO₂ (n=2.35), Al₂O₃ (n=1.62), ZnS (n=2.2), TiO₂ (n=2.35), MgF₂ (n=1.37), HfO₂ (n=1.98), Sc₂O₃ (n=1.9), ThF₄ (n=1.35), Yb₂O₃ (n=1.8), ZrO₂ (n=1.95) and Ta₂O₅ (n=2.1).

Before depositing the multi-layer stack 804, the wafer coated with 0.2 μm Al alloy 101 must be coated with 0.1 μm Ni—P (Step S15) and patterned to define absorbing layer 805 using BF Mask Set 6. The common method of depositing Ni—P is electroplating but, because the top electrode is electrically connected to backplane electronics, electroless plating is chosen to deposit Ni—P following the methods proposed in Refs. [14-16] and the further references cited therein. Unwanted Ni—P is subsequently etched away.

One of the key challenges in the fabrication of the top electrode (101 for Analog MEMS and 101, 805, 804 for Binary MEMS) is the residual stress resulting from the deposition process. Residual stress is partially relieved when the structure is released, resulting in undesired curvature. Residual stress in the deposited film(s) is caused by temperature gradient and/or different thermal expansion coefficients of the deposited layers. This can be controlled by the reducing the substrate temperature.

After the top electrodes (101 for Analog MEMS and 101, 805, 804 for Binary MEMS) are etched, the fabricated structure is covered with thick photoresist. With its surface protected by the photoresist, the wafer is diced (Step S17) to create individual dies to be tiled to produce large display. Special attention should be paid to avoid tiling seams (gaps) between arrayed dies. That not only serves a cosmetic purpose but there is a technical reason as well. In theory, each of these seams can further diffract the light and hence may negatively affect the quality of the holographic image.

Next, in Step S18, the fabricated structures are released by selectively removing the sacrificial polymeric layers utilizing low-temperature (100° C.) O₂, CF₄, and H₂O (gas) chemistry either with radio frequency (RF) or microwave (MW) plasma excitation. MW plasma is, however, preferred because of its distinct benefit over RF. For devices that are sensitive to electrostatic discharge (EDS), MW plasma is ideal for the device release as it results in minimal surface charging effect, because of the high frequency (2.45 GHz) oscillation of electric fields compared to RE plasma (13.56 MHz typically). Finally, the MEMS SLMs are hermetically sealed with a glass window.

Although the invention has been particularly shown and described with references to multiple embodiments, it will be understood by persons skills in the relevant art that various changes in form and details can he made therein without departing from the scope and spirit of the invention. For example, from a design perspective, the size of the MEMS SEM can further be shrunk to increase the viewing angle. As mentioned above, as the size is shrunk, the operating voltage will tend to increase, because of the decreasing area of the capacitatively attracting electrodes 101, 202. To compensate for the increase in operating voltage, it may be possible to decrease the gap g to some extent, but that is limited by the wavelength of light. From fabrication standpoint, to prevent possible geometrical deformation of the polymeric, sacrificial layer during low temperature sputtering, metal electrodes can also be deposited in an electrochemical bath. Alternatively, MEMS SLM can also be fabricated using PECVD polysilicon process and oxide as sacrificial layer.

In this description, terms of orientation, such as “top,” “bottom,” “above,” and “below” are used relative to the orientation of the structures as shown in the drawings, for convenient reference. Those orientations are not limiting, and the disclosed devices may be made, used, transported, and stored in any expedient or convenient orientation.

Aside from the proposed method of holographic display where narrow viewing angle of MEMS SLM is complemented by eye/head tracking to provide wide field of view, small size SLMs can he used to generate true 3D holographic image at wide viewing angle without any complementary approach. Other than holographic displays, MEMS SLM described herein can also be used in other applications such as in holographic storage, where SLM translates digital data into holographic interference patterns to be recorded in photorefractive storage material; optical tweezer, where the light fields emanating out of SLM manipulate microscopic particles; monochromator, where the SLM enables automatic selection of wavelength for fast spectral analysis; and information processing, where SLM is used for optical filtering and pattern matching for real-time target tracking and identification.

### REFERENCES CITED

The following documents are incorporated herein by reference in their entirety, as if set forth fully herein.

[1]. Grigory Lazarev, Andreas Hemierschmidt, Sven Krüger, and Stefan Osten, LCOS Spatial Light Modulators: Trends and Applications, Book Chapter #1, Optical imaging and Metrology: Advanced Technologies, First Edition. Edited by Wolfgang Osten and Nadya Reingand. © 2012 Wiley-VCH Verlag GmbH & Co. KGaA.

[2]. Spatial Light Modulator—XY Series, Data Sheet, Boulder Nonlinear Systems, Inc., Lafayette, Colo. 80026 USA

[3]. Highly Reflective MEMS Device, U.S. Pat. No. 7,957,049 B1

[4]. IMOD Technology Overview, White Paper, Qualcomm MEMS Technologies, Inc. 2009 http://www.qualcomm.com/media/documents/mirasol-displays-imod-technology-overview; http://www.mirasoldisplays.com/

[5]. Larry J. Hornbeck, From cathode rays to digital micromirrors: A history of electronic projection display technology, TI Technical Journal, (15) 3 p. 7-46, (1998).

[6]. Becker et al., MEMS spatial light modulators with integrated electronics. Proceedings of SPIE vol. 4983, 2003

[7]. Mark Lucente, Holographic bandwidth compression using spatial subsampling, Optical Engineering, Special Section on Electronic Holography, 1996 June. Pages 1-25, www.media.mit.edu/spi/SPIPapers/lucerne/OE96.pdf

[8]. Stephan Reichelt, Ralf Haussler, Norbert Leister, Gerald Flatterer, Hagen Stolle and Armin Schwerdtner, Holographic 3-D Displays—Electro-holography within the Grasp of Commercialization, Chapter 29, in “Advances in Lasers and Electro Optics”, edited by Nelson Costa and Adolfo Cartaxo, ISBN 978-953-307-088-9, Published: Apr. 1, 2010.

[9]. http://www.thinfilmcenter.com/essential.html

[10]. Kuniaki Amemiya, Daiji Fukuda, Takayuki Numata, Minoru Tanabe, and Yoshiro Ichino. Comprehensive characterization of broadband ultralow reflectance of a porous nickel—phosphorus black surface by numerical simulation, Applied Optics, Vol. 51, Issue 29, pp. 6917-6925 (2012). http://dx.doi.org/10.13641AO.51.006917

[11]. Scott R Hunter, High-sensitivity uncooled microcantilever infrared imaging arrays, Proceedings of SPIE (2006), Volume: 6206, Publisher: Spie, Pages: 62061J-62061J-12

[12]. Yukiteru Matsui, Satoko Seta, Masako Kinoshita, Yoshikuni Tateyama, Atsushi Shigeta, Takeshi Nishioka, Hiroyuki Yano, Hirotaka Shida, Kazuo Nishimoto, Masabumi Masuko, High Performance Photoresist Planarization Process by CMP with Resin Abrasive for Trench-First Cu/Low-k Dual Damascene Process, Journal of The Electrochemical Society, Vol. 156, No. 7. (2009), pp. H548-H554 Key: citeulike:4484229

[13]. Lance W. Barron, High-Reflectance Sputter-Deposited Aluminum Allay Thin Films for Micro-Electro-Mechanical Systems, MS Thesis (2005), Rochester Institute of Technology.

[14], S. Kodama, M. Horiuchi, T. Kunii, and K. Kuroda, “Ultra-black nickel-phosphorus alloy optical absorber,” IEEE Trans. Instruments and Measurements, Volume: 39, Issue: 1 Page(s): 230-232, (February 1990)

[15]. Peelers, P., Hoorn, G., Daenen, T., Kurowski, A., Staikov, G. (2001) “Properties of electroless and electroplated Ni—P and its application in microgalvanies”. Electrochimica Acta, Vol. 47 Page: 161-169(2001)

[16]. Richard J. C. Brown, Paul J. Brewer and Martin J. T. Milton, The physical and chemical properties of electroless nickel-phosphorus alloys and low reflectance nickel-phosphorus black surfaces, J. Mater. Chem., 12, 2749-2754 (2002)

What is claimed is:

1. A micromirror device comprising:
a substrate;
a first electrode spaced from and parallel with a surface of the substrate and having a reflective surface directly on the first electrode;
a plurality of posts on the substrate, within an area occupied by the first electrode in a direction parallel to the substrate, and having distal ends spaced apart from a side of the first electrode facing towards the substrate;
a respective plurality of flexure arms, each extending from a distal end of a respective one of the posts, between the first electrode and the substrate, within an area occupied by a side portion of the first electrode in a direction parallel to the substrate, and spaced apart from the substrate and from the first electrode, to a free end;
a respective plurality of anchors, each extending from a respective one of the distal ends of the flexure arms away from the substrate, and joining the first electrode directly to the flexure arms; and
a second electrode on the substrate facing the first electrode.

2. The device of claim 1, wherein the posts, flexure arms, and anchors are electrically conductive, further comprising circuitry in the substrate operative to deliver electricity to the first electrode via the posts.

3. The device of claim 1, further comprising circuitry in the substrate operative to deliver different electrical voltages to the first and second electrodes so as to cause the first electrode to be attracted towards the second electrode against a restoring force arising from flexing of the flexure arms.

4. The device of claim 3, wherein the circuitry is operative to control the position of the first electrode over a range of positions in an analog manner by controlling the applied voltage over a range of voltages.

5. The device of claim 4, wherein the circuitry is operative to control the position of the first electrode over a range of positions z such that 0<z<g/3, where z=0 is an inactive position with no applied voltage, and g is the spacing between the first and seconds electrodes when z=0.

6. The device of claim 3, wherein the circuitry is operative to control the position of the first electrode in binary manner by applying a voltage sufficient to erase the first electrode to contact the posts.

7. The device of claim 6, wherein said applied voltage causes the first electrode to pass a pull-in point and snap into engagement with the posts.

8. The device of claim 1, wherein a center portion of the first electrode extends towards the substrate to a level directly between the flexure arms.

9. The device of claim 8, wherein in an unstressed condition with no voltage applied to the first and second electrodes, a surface of the center portion of the first electrode facing towards the substrate is substantially flush with surfaces of the flexure arms facing towards the substrate.

10. The device of claim 1, wherein, in an unstressed condition with no voltage applied to the first and second electrodes, the spacing, between the first electrode and flexure arms is less than the spacing between the first electrode and the second electrode.

11. The device of claim 1, wherein the first electrode comprises Al alloyed with one or more elements selected from the group consisting of Si, transition metals, silicon, polysilicon, and possible combinations thereof.

12. The device of claim 1, further comprising, on a face of the first electrode away from the substrate, a dichroic filter and a Ni—P alloy absorber between the first electrode and the dichroic filter to selectively reflect a narrow band of red, green or blue color light and absorb remaining visible wavelengths.

13. The device of claim 12, wherein the dichroic filter comprises alternating layers of higher and lower refractive index (n) materials.

14. The device of claim 1, further comprising, on a face of the first electrode away from the substrate, a high-reflectivity metal thin-film or to reflect light in the visible spectrum.

15. A light phase modulator comprising an array of devices according to claim 1, and control circuitry operative to apply voltages to the first and second electrodes to cause the first electrodes of the devices to adopt selected relative positions to modulate the phase of light reflected from them.

16. The light phase modulator of claim 15, further comprising a dichroic filter on a face of the first electrode of each said device away from the substrate, to selectively reflect a narrow hand of wavelengths of visible light wherein different ones of said filters are selected to reflect red, green, and blue color light.

17. A method of fabrication of an array of spatial light modulators, comprising successively forming a plurality of sacrificial layers and a plurality of conducting levels.

18. The method of fabrication of claim 17, comprising two sacrificial steps to define a maximum travel distance (z₀) for a movable electrode remote from a substrate, and an operating gap for electrostatic actuation.

19. The method of fabrication of claim 17, wherein the fabrication is low temperature processing below 300° C.

20. The method of fabrication of claim 17, wherein chemical mechanical polishing is used to planarize a surface of a thin film and set the thin film to a predetermined thickness.
